(19) United States
(12) Patent Application Publication
(10) Pub. No.: US 2026/0234895 A1
(43) Pub. Date: Aug. 13, 2026

(54) HYDRAULIC SYSTEM MANAGEMENT METHOD FOR MACHINE CONTROL

(71) Applicant: Deere & Company, Moline, IL (US)

(72) Inventors: Aaron R. Kenkel, Hazel Green, WI (US); Bryan J. Rausch, Durango, IA (US); Jeffery W. Dobchuk, Saskatoon (CA); Justin Sticksel, Platteville, WI (US)

(21) Appl. No.: 19/050,933

(22) Filed: Feb. 11, 2025

(51) Int. Cl. E02F 3/42; E02F 3/32; E02F 3/43; E02F 9/20; E02F 9/22; E02F 9/26; F15B 11/17; F15B 13/06

(52) U.S. Cl. CPC E02F 3/425; E02F 3/32; E02F 3/435; E02F 9/2004; E02F 9/2271; E02F 9/2292; F15B 11/17; F15B 13/06; E02F 9/2203; E02F 9/26

(57) ABSTRACT

In a control system for a work machine a controller is configured to: receive a signal indicating a selected operating mode; receive an operating command for performance of a work task; determine a needed flow rate of hydraulic fluid needed by each of the hydraulic actuators; determine a flow split for each hydraulic actuator, the flow split being based at least in part on the selected operating mode, wherein for each of the operating modes a percentage of the needed flow rate to be provided from the secondary control valve associated with the hydraulic actuator is greater than zero; and provide command signals to each of the primary control valves and secondary control valves to accomplish the determined flow split for each of the hydraulic actuators.

### BACKGROUND OF THE DISCLOSURE

### 1. Field of the Disclosure

The present disclosure relates to a system for managing a hydraulic system of a work machine to improve sharing of available hydraulic power among hydraulic actuators.

### 2. Description of the Prior Art

Machine control systems providing automation on construction equipment require the ability to precisely manage the machine actuators. This requires a precise means to control the flow of oil within the machine's hydraulic system. On many machine platforms, a single hydraulic pump may be used as a primary flow source for one actuator and may be utilized as a secondary (supplemental) flow source for a second actuator. Managing the split of hydraulic flow when these two actuators are being operated simultaneously can be challenging, and in many cases the machine control system will eliminate the availability of secondary flow for actuators to avoid this situation when operating in automation modes.

Eliminating secondary (supplemental) flow limits the overall actuator velocities that could be achieved when operating in an automation mode, and therefore limits the overall performance of the system.

There is a need for improved control systems for management of the hydraulic system of such work machines to improve sharing of available hydraulic power.

### SUMMARY OF THE DISCLOSURE

The present disclosure provides a system to manage flow sharing between actuators in order to optimize automated system performance.

In one embodiment a work machine includes a machine frame, a boom pivotally connected to the machine frame, an arm pivotally connected to the boom, and a work implement connected to the arm. A hydraulic boom actuator pivots the boom relative to the machine frame. A hydraulic arm actuator pivots the arm relative to the boom. A hydraulic boom supply pump primarily provides hydraulic fluid to the boom actuator. A hydraulic arm supply pump primarily provides hydraulic fluid to the arm actuator. A boom primary valve is configured to control flow of hydraulic fluid from the hydraulic boom supply pump to the hydraulic boom actuator. A boom secondary valve is configured to control flow of hydraulic fluid from the hydraulic arm supply pump to the hydraulic boom actuator. An arm primary valve is configured to control flow of hydraulic fluid from the hydraulic arm supply pump to the hydraulic arm actuator. An arm secondary valve is configured to control flow of hydraulic fluid from the hydraulic boom supply pump to the hydraulic arm actuator. An operator input is configured to allow a human operator of the work machine to select a selected operating mode from a group of selectable operating modes, the selected operating mode corresponding to a degree of precision selected for accomplishing a work task. At least one parameter sensor is configured to detect a machine parameter corresponding to an operating condition of the work machine. A controller is configured to: receive a signal indicating the selected operating mode; receive an operating command for operation of the work implement; determine a target hydraulic flow to the hydraulic boom actuator and a target hydraulic flow to the hydraulic arm actuator to perform the operating command; determine a flow split of the hydraulic flow to be provided to the hydraulic boom actuator between a boom primary flow fraction from the hydraulic boom supply pump and a boom secondary flow fraction from the hydraulic arm supply pump, based at least in part on at least one of the selected operating mode or the operating condition; determine a flow split of the hydraulic flow to be provided to the hydraulic arm actuator between an arm primary flow fraction from the hydraulic arm supply pump and an arm secondary flow fraction from the hydraulic boom supply pump, based at least in part on at least one of the selected operating mode or the operating condition; determine a boom primary flow request command to the boom primary valve based at least in part on the target hydraulic flow to the hydraulic boom actuator and the boom primary flow fraction; determine a boom secondary flow request command to the boom secondary valve based at least in part on the target hydraulic flow to the hydraulic boom actuator and the boom secondary flow fraction; determine an arm primary flow request command to the arm primary valve based at least in part on the target hydraulic flow to the hydraulic arm actuator and the arm primary flow fraction; and determine an arm secondary flow request command to the arm secondary valve based at least in part on the target hydraulic flow to the hydraulic arm actuator and the arm secondary flow fraction.

In another embodiment a work machine includes a plurality of hydraulic actuators and a plurality of hydraulic pumps, each of the hydraulic pumps being primarily associated with a different one of the hydraulic actuators. A plurality of primary control valves are each associated with a different one of the hydraulic actuators. A plurality of secondary control valves are each associated with a different one of the hydraulic actuators. An operator input is configured to allow a human operator of the work machine to select a selected operating mode from a group of operating modes, the selected operating mode corresponding to a degree of precision selected for accomplishing a work task. A controller is configured to: receive a signal indicating the selected operating mode; receive an operating command for performance of the work task; determine a needed flow rate of hydraulic fluid needed by each of the hydraulic actuators to perform the work task; determine a flow split for each hydraulic actuator, the flow split defining a percentage of the needed flow rate to be provided from each of the primary control valve and the secondary control valve associated with the hydraulic actuator, the flow split being based at least in part on the selected operating mode, wherein for each of the operating modes the percentage of the needed flow rate to be provided from the secondary control valve associated with the hydraulic actuator is greater than zero; and provide command signals to each of the primary control valves and secondary control valves to accomplish the determined flow split for each of the hydraulic actuators.

In a further embodiment a method of operating a work machine is provided. The work machine includes a machine frame, a boom pivotally connected to the machine frame, an arm pivotally connected to the boom, a work implement connected to the arm, a hydraulic boom actuator arranged to pivot the boom relative to the machine frame, and a hydraulic arm actuator arranged to pivot the arm relative to boom. The method comprises:
receiving in an automatic controller a signal indicating a selected operating mode from a group of selectable operating modes, the selected operating mode corresponding to a degree of precision selected for accomplishing a work task with the work implement;
receiving in the automatic controller an operating command for operation of the work implement;
determining with the automatic controller a target hydraulic flow to the hydraulic boom actuator and a target hydraulic flow to the hydraulic arm actuator to perform the operating command;
determining with the automatic controller a flow split of the hydraulic flow to be provided to the hydraulic boom actuator between a boom primary flow fraction from a hydraulic boom supply pump and a boom secondary flow fraction from a hydraulic arm supply pump, based at least in part on the selected operating mode or based at least in part on an operating condition of the work machine;
determining with the automatic controller a flow split of the hydraulic flow to be provided to the hydraulic arm actuator between an arm primary flow fraction from the hydraulic arm supply pump and an arm secondary flow fraction from the hydraulic boom supply pump, based at least in part on the selected operating mode or based at least in part on the operating condition of the work machine;
determining with the automatic controller a boom primary flow request command to a boom primary valve based at least in part on the target hydraulic flow to the hydraulic boom actuator and the boom primary flow fraction;
determining with the automatic controller a boom secondary flow request command to a boom secondary valve based at least in part on the target hydraulic flow to the hydraulic boom actuator and the boom secondary flow fraction;
determining with the automatic controller an arm primary flow request command to an arm primary valve based at least in part on the target hydraulic flow to the hydraulic arm actuator and the arm primary flow fraction; and
determining with the automatic controller an arm secondary flow request command to an arm secondary valve based at least in part on the target hydraulic flow to the hydraulic arm actuator and the arm secondary flow fraction.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a left side view of a work machine, for example an excavator, including the hydraulic control system of the present disclosure.

FIG. 2 is a schematic drawing of the hydraulic system of the excavator.

FIG. 3 is a schematic drawing of the control system of the excavator.

FIG. 4 is a flow chart depicting one embodiment of the control logic of the control system.

FIG. 5 is a schematic illustration of several operating modes of the control system.

FIG. 6 is a schematic illustration of further operating modes of the control system.

### DETAILED DESCRIPTION

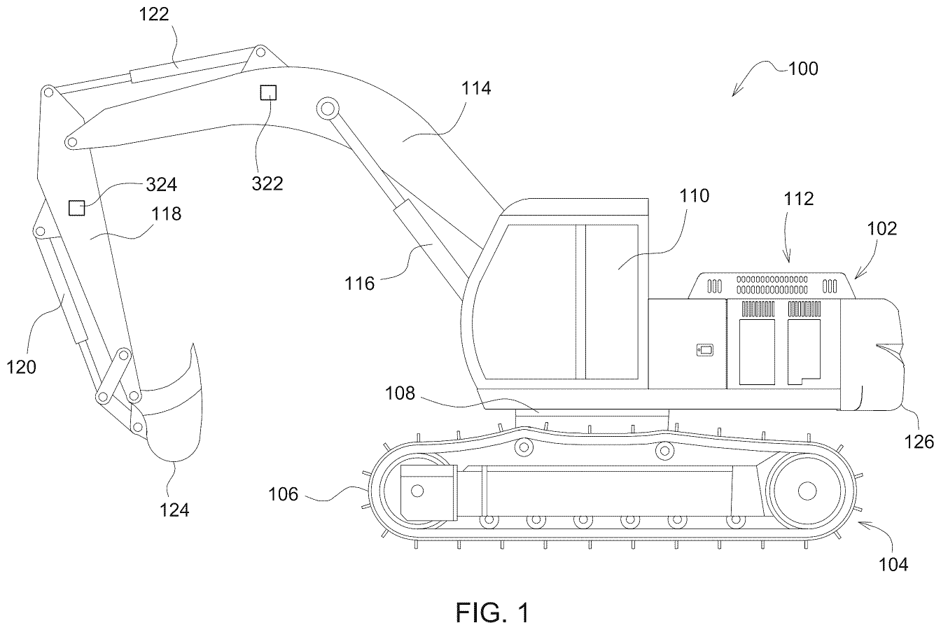

An example of a work machine is shown in FIG. 1. The machine is embodied as an excavator 100. The present disclosure is not limited, however, to an excavator and may extend to other work machines such as a loader, crawler, harvester, skidder, backhoe, feller buncher, motor grader, or any other work machine. As such, while the figures and forthcoming description may relate to an excavator, it is to be understood that the scope of the present disclosure extends beyond an excavator and, where applicable, the term “machine” or “work machine” will be used instead. The term “machine” or “work machine” is intended to be broader and encompass other vehicles besides an excavator for purposes of this disclosure.

Referring to FIG. 1, the machine 100 includes a chassis comprising an upper frame 102 pivotally mounted to an undercarriage 104. The upper frame 102 can be pivotally mounted on the undercarriage 104 by means of a swing pivot 108. The upper frame 102 is rotatable about 360 degrees relative to the undercarriage 104 on the swing pivot 108. A hydraulic motor (not shown) can drive a gear train (not shown) for pivoting the upper frame 102 about the swing pivot 108.

The undercarriage 104 can include a pair of ground-engaging mechanisms such as tracks 106 on opposite sides of the undercarriage 104 for moving along the ground. Alternatively, the machine 100 can include more than two tracks or wheels for engaging the ground. The upper frame 102 includes a cab 110 in which the machine operator controls the machine.

The machine 100 also includes a boom 114 that extends from the upper frame 102 adjacent to the cab 110. The boom 114 is rotatable about a vertical arc by actuation of a pair of boom cylinders 116, only one of which is visible in FIG. 1. A dipper stick or arm 118 is rotatably mounted at one end of the boom 114 and its position is controlled by a hydraulic arm cylinder 122. There may be two hydraulic arm actuators 122. At the end opposite the boom 114, the dipper stick or arm 118 is rotatably coupled to a work implement or bucket 124 that is pivotable relative to the arm 118 by means of a hydraulic implement pivoting cylinder 120. There may be two hydraulic implement pivoting cylinders 120.

The upper frame 102 of the machine 100 includes an outer shell cover over an engine assembly 112. At an end opposite the cab 110, the upper frame 102 includes a counterweight body 126. The counterweight body 126 comprises a housing filled with material to add weight to the machine and offset a load collected in the bucket 124. The offset weight can improve the craning or digging performance characteristics of the machine 100.

The operator of the machine 100 may manually control the boom cylinders 116, the hydraulic arm cylinders 122, the hydraulic implement pivoting cylinders 120 and the hydraulic motor that pivots the upper frame 102 about the undercarriage 104 on the swing pivot 108.

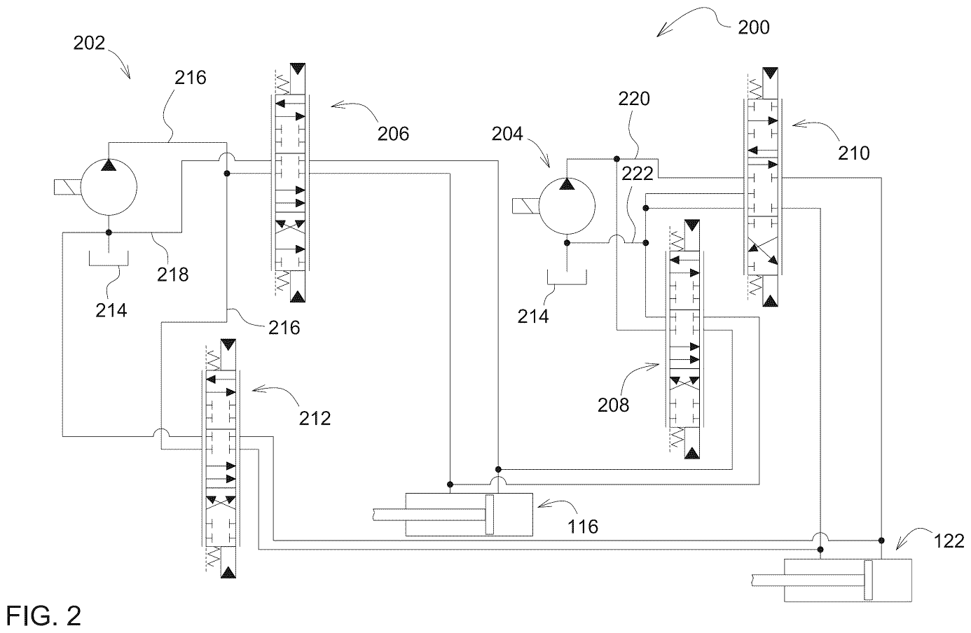

FIG. 2 shows portions of a hydraulic system 200 of the machine 100. The hydraulic system 200 includes a hydraulic boom supply pump 202 and a hydraulic arm supply pump 204. The hydraulic boom supply pump 202 is primarily used to provide hydraulic flow to the boom cylinders 116 but may also be used as a source for other hydraulic components, including use as a secondary source to the hydraulic arm cylinders 122. The hydraulic arm supply pump 204 is primarily used to provide hydraulic flow to the arm cylinders 122 but may also be used as a source for other hydraulic components, including use as a secondary source to the hydraulic boom cylinders 116.

A boom primary valve 206 is configured to control flow of hydraulic fluid from the hydraulic boom supply pump 202 to the boom cylinders 116. A boom secondary valve 208 is configured to control flow of hydraulic fluid from the hydraulic arm supply pump 204 to the boom cylinders 116.

An arm primary valve 210 is configured to control flow of hydraulic fluid from the hydraulic arm supply pump 204 to the hydraulic arm actuator 122. An arm secondary valve 212 is configured to control flow of hydraulic fluid from the hydraulic boom supply pump 202 to the hydraulic arm actuator 122.

The hydraulic boom supply pump 202 supplies hydraulic fluid from tank 214 to boom primary valve 206 and arm secondary valve 212 via first supply line 216. Low pressure fluid returning from the valves and actuators is directed back to the tank 214 via first return line 218.

The hydraulic arm supply pump 204 supplies hydraulic fluid from the tank 214 to arm primary valve 210 and boom secondary valve 208 via second supply line 220. Low pressure fluid returning from the valves and actuators is directed back to the tank 214 via second return line 222. Both the hydraulic boom supply pump 202 and the hydraulic arm supply pump 204 are show as drawing fluid from the same tank 214, but it will be understood they could also use separate tanks.

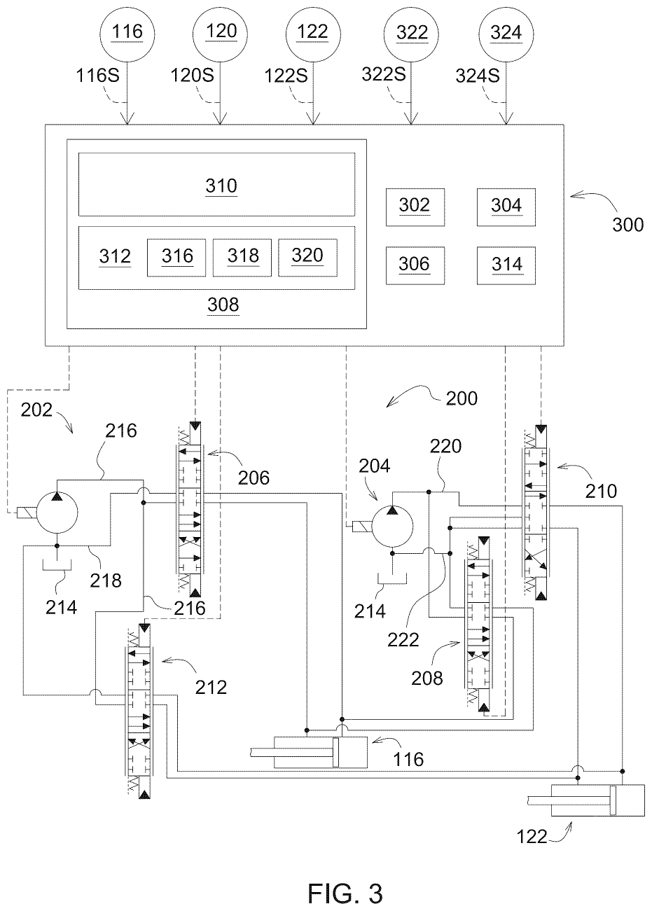

As schematically illustrated in FIG. 3, the working machine 100 includes a controller 300. The controller 300 may also be referred to as an automatic controller 300. The controller 300 is connected with the boom primary valve 206, boom secondary valve 208, arm primary valve 210 and arm secondary valve 212 by electronic communication lines indicated in dashed lines. The controller 300 is also connected with control lines to the pumps 202 and 204. The controller 300 may be part of the machine control system of the working machine 100, or it may be a separate control module. The controller 300 may be mounted in the operators'cab 110.

The controller 300 is configured to receive input signals from various sensors and operator inputs. For example, the grade control system programmed into the controller 300 will receive GPS position signals from GPS receivers carried by work machine 100. The grade control system will also receive boom assembly position signals from various sensors mounted on the boom assembly. Such boom assembly position sensors may include a boom position sensor 322 and an arm position sensor 324, each in the form of an Inertial Measurement Unit (IMU) mounted on the boom or the arm. Other forms of the boom assembly position sensors could include integrated extension sensors 116S, 122S, and 120S included in each of the hydraulic actuators 116, 122 and 120, respectively, in the form of “smart cylinders”. All such boom assembly position sensors may be generally referred to as parameter sensors configured to detect a machine parameter corresponding to an operating condition of the work machine. Other parameter sensors may include sensors for detecting whether various auxiliary hydraulic components of the work machine 100 are actively functioning and thus need hydraulic power.

The controller 300 will also receive an input defining the desired work project by defining the desired grade elevation at a given geographic position. Based on those input signals the grade control system of the controller 300 will supplement manual inputs from the operator to control operation of the boom assembly to achieve the desired grade.

Controller 300 includes or may be associated with a processor 302, a computer readable medium 304, a data base 306 and an input/output module or control panel 308 having a display 310. An operator input 312 in the form of an input/output device, such as a keyboard, joystick or other user interface, is provided so that the human operator may input instructions to the controller. It is understood that the controller 300 described herein may be a single controller having all of the described functionality, or it may include multiple controllers wherein the described functionality is distributed among the multiple controllers.

Various operations, steps or algorithms as described in connection with the controller 300 can be embodied directly in hardware, in a computer program product 314 such as a software module executed by the processor 302, or in a combination of the two. The computer program product 314 can reside in RAM memory, flash memory, ROM memory, EPROM memory, EEPROM memory, registers, hard disk, a removable disk, or any other form of computer-readable medium 304 known in the art. An exemplary computer-readable medium 304 can be coupled to the processor 302 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

In FIG. 3 the hydraulic system 200 previously described with regard to FIG. 2 is also illustrated, to show the interconnections between the controller 300 and the hydraulic system 200.

The operator input 312 may be configured to allow a human operator of the work machine 100 to select a selected operating mode from a group of selectable operating modes, the selected operating mode corresponding to a degree of precision selected for accomplishing a work task. For example, the operator input 312 may include three buttons from which the operator may select a higher speed-lower precision operating mode, medium speed-medium precision operating mode or lower speed-higher precision operating mode. As schematically shown in FIG. 3, the three buttons may include a higher speed-lower precision mode selection button 316, a medium speed-medium precision mode selection button 318 and a lower speed-higher precision mode selection button 320. The buttons may be hard wired, or they may be virtual buttons displayed on a touchscreen portion of display 310.

Such selections of the degree of precision are available in a typical grade control system of the work machine 100. Typically, a higher speed-lower precision mode selection would be used by the operator for roughly grading a site. The lower speed-higher precision mode selection would be used to deliver optimal grading precision, but would do so by sacrificing grading speed. The medium speed-medium precision mode selection could be selected in intermediate situations.

The present disclosure is directed to a management system for controlling the hydraulic system 200 of the work machine 100 in a manner that can optimize machine performance. Depending in part upon the selection of the degree of precision by the operator, such as via mode selection buttons 316, 318, 320, hydraulic fluid may be directed to each hydraulic actuator from both a primary and a secondary control valve associated with that actuator.

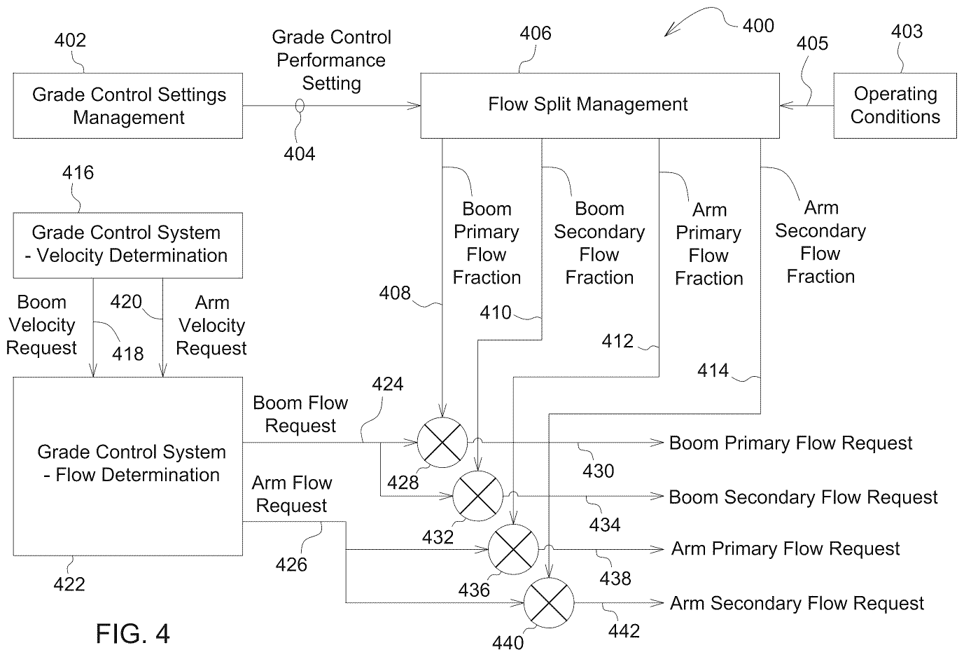

FIG. 4 is a flow chart of a control logic 400 which may be embodied in software programming of the computer program product 314 stored in the computer readable medium 304.

Block 402 represents a grade control settings management function which may incorporate the selection of the degree of grading precision as discussed above using the buttons 316, 318 and 320. A grade control performance setting signal 404 is then received by a flow split management function 406.

The controller 300 may also monitor various operating conditions of the work machine 100 as indicated at block 403. This may be done using at least one parameter sensor configured to detect a machine parameter corresponding to an operating condition of the work machine. For example, as noted above such parameter sensors may include boom position sensor 322, arm position sensor 324, or integrated extension sensors 116S, 122S and 120S. A parameter sensor signal 405 is then received by the flow split management function 406. Other parameter sensors may include sensors for detecting whether various auxiliary hydraulic components of the work machine 100 are actively functioning and thus need hydraulic power.

The flow split management function 406 may then determine the appropriate flow splits based at least in part on at least one of the selected operating mode or the operating condition. The phrase “based at least in part on at least one of the selected operating mode or the operating condition” means that the flow split management function may determine the appropriate flow splits based in part on the operating mode, or based in part on the operating condition, or based in part on both the operating mode and the operating condition,

The flow split management function 406 will determine a flow split of the hydraulic flow to be provided to the hydraulic boom actuator 116 between a boom primary flow fraction 408 from the hydraulic boom supply pump 202 and a boom secondary flow fraction 410 from the hydraulic arm supply pump 204, based at least in part on at least one of the selected operating mode or the operating condition. The flow split management function 406 will also determine a flow split of the hydraulic flow to be provided to the hydraulic arm actuator 122 between an arm primary flow fraction 412 from the hydraulic arm supply pump 204 and an arm secondary flow fraction 414 from the hydraulic boom supply pump 202, based at least in part on at least one of the selected operating mode or the operating condition.

The controller 300 also receives an operating command for operation of the work implement 124. This operating command will come from the operator in the cab 110 and may be modified by the grade control system. Based on that operating command a velocity determination function 416 of the software determines a boom velocity request 418 and an arm velocity request 420 which are sent to a flow determination function 422 of the software. The flow determination function 422 is configured to determine a target hydraulic flow 424 to the hydraulic boom actuator 116 and a target hydraulic flow 426 to the hydraulic arm actuator 122 to perform the operating command.

As indicated at block 428 the control logic 400 determines a boom primary flow request command 430 to the boom primary valve 206 based at least in part on the target hydraulic flow 424 to the hydraulic boom actuator 116 and the boom primary flow fraction 408.

As indicated at block 432 the control logic 400 determines a boom secondary flow request command 434 to the boom secondary valve 208 based at least in part on the target hydraulic flow 424 to the hydraulic boom actuator 116 and the boom secondary flow fraction 410.

As indicated at block 436 the control logic 400 determines an arm primary flow request command 438 to the arm primary valve 210 based at least in part on the target hydraulic flow 426 to the hydraulic arm actuator 122 and the arm primary flow fraction 412.

As indicated at block 440 the control logic 400 determines an arm secondary flow request command 442 to the arm secondary valve 212 based at least in part on the target hydraulic flow 426 to the hydraulic arm actuator 122 and the arm secondary flow fraction 414.

The flow split management function 406 may be configured such that for each of the selectable operating modes 316, 318, 320, the arm secondary flow fraction 414 and the boom secondary flow fraction 410 are each greater than zero. Thus, regardless of the level of grading precision selected by the operator, at least some portion of the hydraulic fluid provided to each actuator may be provided via the secondary valve associated with that actuator. It will also be appreciated that in any of the selectable levels of grading precision, there may be times when the flow demand is so low that it is easily provided by the respective primary flow fraction and the secondary flow fraction may be zero or near zero.

The flow split management function 406 may be configured such that for any detected operating condition, the arm secondary flow fraction 414 and the boom secondary flow fraction 410 are each greater than zero. Thus, regardless of the detected operating condition, at least some portion of the hydraulic fluid provided to each actuator may be provided via the secondary valve associated with that actuator. It will also be appreciated that for some detected operating conditions, there may be times when the flow demand is so low that it is easily provided by the respective primary flow fraction and the secondary flow fraction may be zero or near zero.

The flow split management function 406 may be configured such that the flow splits are adjusted such that a heavier flow rate is provided to the primary control valve associated with each actuator in the lower speed-higher precision mode. This allows for the most precise performance by limiting the load dependency between the boom and arm functions. Likewise, the system may favor a more equal flow split to the primary/secondary valves when in higher speed-lower precision mode, which offers the ability for the system to deliver high speeds for rough grading operations. Such a system may be described as the controller 300 being configured to provide a higher boom primary flow fraction 408 in the lower speed-higher precision mode 320 than in the higher speed-lower precision mode 316, and to provide a higher arm primary flow fraction 412 in the lower speed-higher precision mode 320 than in the higher speed-lower precision mode 316.

The flow split management function 406 may be configured such that the flow splits are adjusted based on the detected operating conditions.

One example of an adjustment of flow splits based at least in part on the detected operating conditions is encountered when the grade angle encountered by the work implement changes. For example, when the work implement 124 is grading flat and extra flow is available from the boom supply pump 202, a higher arm secondary flow fraction 414 may be made available from the hydraulic boom supply pump 202 to the hydraulic arm actuator 122. However, if during the same pass, the trajectory of the work implement 124 transitions to a positive slope, the hydraulic boom actuator 116 may require more hydraulic flow to stay on grade so the flow fraction from the hydraulic boom supply pump 202 that is allowed to go to the hydraulic arm actuator 122 may be limited.

Another example would be where the work implement 124 is grading flat and, and the controller 300 detects from the grade control settings that the hydraulic implement pivoting cylinder 120 is not being used. In this case there is no need to reserve any flow from the hydraulic boom supply pump 202 for the hydraulic implement pivoting cylinder 120 and more flow can be diverted to the hydraulic arm actuator 122 for maximum arm speed.

Another example would be based on the controller 300 detecting whether any of the auxiliary hydraulic components of the work machine 100 are actively functioning. If flow is needed for those auxiliary hydraulic components, the less flow may be diverted to the secondary flow fraction associated with the affected hydraulic pump.

The system described above with regard to FIGS. 2-4 has been described with regard to hydraulic fluid sharing between two hydraulic actuators 116, 122 each of which has a hydraulic pump primarily associated with the actuator, and each of which has a primary valve and a secondary valve associated with the actuator. Such an operational system may be expanded to include a third actuator, such as for example the hydraulic implement pivoting cylinder 120. In general, such an expanded system may be describe as having a plurality of hydraulic actuators (116, 122, 120). The expanded system likewise could include a plurality of hydraulic pumps, each of the hydraulic pumps being primarily associated with a different one of the hydraulic actuators. The system could further include a plurality of primary control valves, each of the primary control valves being associated with a different one of the hydraulic actuators and a plurality of secondary control valves, each of the secondary control valves being associated with a different one of the hydraulic actuators.

The controller 300 associated with such an expanded system would similarly receive a signal indicating the selected operating mode; receive an operating command for performance of the work task; determine a needed flow rate of hydraulic fluid needed by each of the hydraulic actuators to perform the work task; determine a flow split for each hydraulic actuator, the flow split defining a percentage of the needed flow rate to be provided from each of the primary control valve and the secondary control valve associated with the hydraulic actuator, the flow split being based at least in part on the selected operating mode, wherein for each of the operating modes the percentage of the needed flow rate to be provided from the secondary control valve associated with the hydraulic actuator is greater than zero; and provide command signals to each of the primary control valves and secondary control valves to accomplish the determined flow split for each of the hydraulic actuators.

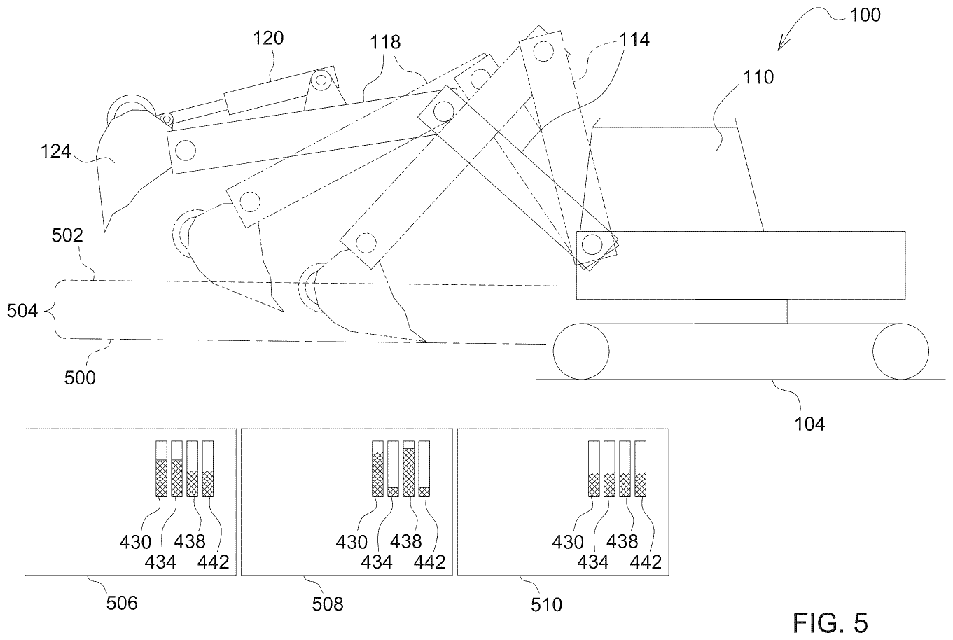

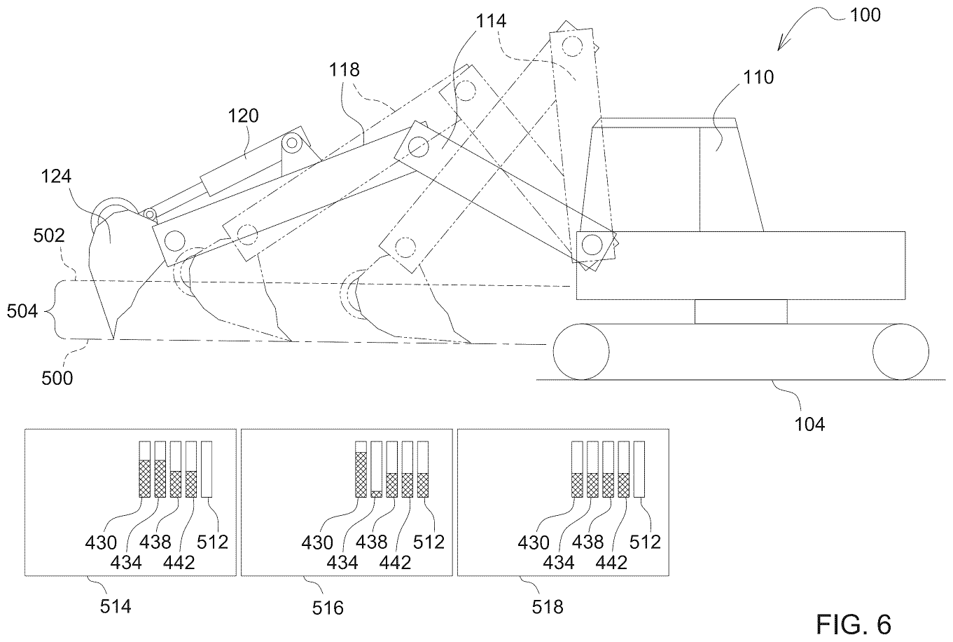

Several further examples are schematically represented in FIGS. 5 and 6. The operator input 312 is further configured to allow the human operator of the work machine 100 to select between a manual control mode and a grade control mode when operating the bucket 124. The controller 300 may be configured adjust the flow split of the hydraulic flow to be provided to the hydraulic boom actuator 116 and/or the flow split of the hydraulic flow to be provided to the hydraulic arm actuator 122, in response to a change between the manual control mode and the grade control mode.

In FIG. 5 the work machine 100 is schematically shown along with a target grade 500 which represents the desired graded surface to be created by the machine 100 under control of the grade control system. A dashed line represents an upper limit 502 of a grade control window 504 between the upper limit 502 and the target grade 500. The boom 114, arm 118 and bucket 124 are shown in solid lines in an uppermost position wherein the bucket 124 is located above the upper limit 502 of the grade control window 504. Two dashed line positions of the boom 114, arm 118 and bucket 124 represent an intermediate position wherein the bucket 124 is entering the grade control window 504, and an on-grade position wherein cutting edge of the bucket 124 is located at target grade 500.

In a first example such as in the solid line position of the boom 114, arm 118 and bucket 124 while manually operating the boom assembly towards the grade control window 504, full flow can be distributed to both the primary and secondary valves associated with each hydraulic actuator based on normal manual control tuning. This is pictorially represented in block 506 by four rectangles wherein the solid filled portion of the rectangle represents a level of the boom primary flow request command 430, the boom secondary flow request command 434, the arm primary flow request command 438 and the arm secondary flow request command 442. In the embodiment represented by block 506, the controller 300 is configured such that when the operator is manually controlling movement of the work implement 124 toward the target grade 500 the boom primary flow request 430 and the boom secondary flow request 434 are each greater than each of the arm primary flow request 438 and the arm secondary flow request 442.

Block 508 represents the intermediate position of the boom 114, arm 118 and bucket 124 while in the grade control window 504, wherein the grade control system takes over and flow may be distributed more heavily towards the respective primary valves to control the approach of the bucket 124 to the target grade 500. In the embodiment represented by block 508 the controller 300 is configured such that when the operator is controlling movement of the work implement 124 within the grade control window 504 the boom primary flow request 430 and the arm primary flow request 438 are each greater than each of the boom secondary flow request 434 and the arm secondary flow request 442.

Block 510 represents the lowermost position of the boom 114, arm 118 and bucket 124 while in the grade control window 504, wherein bucket 124 is on target grade 500. Overall speed may be reduced and if velocity targets are consistent, flow may be more evenly split. In the embodiment represented by block 510 the controller 300 is configured such that when the operator is controlling movement of the work implement 124 on the target grade 500, the boom primary flow request 430 is substantially equal to the boom secondary flow request 434, and the arm primary flow request 438 is substantially equal to the arm secondary flow request 442. In this context, “substantially equal” means plus or minus 10%.

FIG. 6 schematically represents several further examples, in which the bucket 124 is operating on the target grade 500, and an additional hydraulic actuator of an auxiliary component 512 is sometimes operated and has a need to draw hydraulic power from one or both of the hydraulic pumps.

Block 514 represents the uppermost solid line positions in FIG. 6 of the boom 114, arm 118 and bucket 124 while on the target grade 500, when there is no operation of the auxiliary component 512. In this example the flow distribution is similar to that described with regard to block 506 above.

Block 516 represents the intermediate position of the boom 114, arm 118 and bucket 124 while on the target grade 500, when the auxiliary component 512 is operating. While operating auxiliary component 512, flow may need to be distributed from one of the other functions to the auxiliary component 512. In the illustrated embodiment the boom secondary flow request 434 has been reduced in order to make available hydraulic flow to the auxiliary component 512. In this example, the controller 300 is configured such that when the operator is controlling movement of the work implement 124 within the grade control window 504 or on grade 500, and the auxiliary powered hydraulic component 512 is being simultaneously operated, hydraulic flow is distributed from one or both of the hydraulic boom supply pump 202 and the hydraulic arm supply pump 204 to the auxiliary hydraulically powered component 512.

Block 518 represents a further example, while operating on target grade 500, when the auxiliary component 512 is not operating. Overall speed may be reduced, and if velocity targets are consistent, flow may be more evenly split.

In a further embodiment a method of operating the work machine 100 is provided. The method comprises:
receiving in the automatic controller 300 the grade control performance setting signal 404 indicating the selected operating mode from the group of selectable operating modes, the selected operating mode corresponding to a degree of precision selected for accomplishing a work task with the work implement 124;
receiving in the automatic controller 300 an operating command for operation of the work implement 124;
determining with the automatic controller 300 the target hydraulic flow 424 to the hydraulic boom actuator 116 and the target hydraulic flow 426 to the hydraulic arm actuator 122 to perform the operating command;
determining with the automatic controller 300 the flow split of the hydraulic flow to be provided to the hydraulic boom actuator 116 between the boom primary flow fraction 408 from the hydraulic boom supply pump 202 and the boom secondary flow fraction 410 from the hydraulic arm supply pump 204, based at least in part on the selected operating mode or based at least in part on an operating condition of the work machine;
determining with the automatic controller 300 the flow split of the hydraulic flow to be provided to the hydraulic arm actuator 122 between the arm primary flow fraction 412 from the hydraulic arm supply pump 204 and the arm secondary flow fraction 414 from the hydraulic boom supply pump 202, based at least in part on the selected operating mode or based at least in part on the operating condition of the work machine;
determining with the automatic controller 300 the boom primary flow request command 430 to the boom primary valve 206 based at least in part on the target hydraulic flow 424 to the hydraulic boom actuator 116 and the boom primary flow fraction 408;
determining with the automatic controller 300 the boom secondary flow request command 434 to the boom secondary valve 208 based at least in part on the target hydraulic flow 424 to the hydraulic boom actuator 116 and the boom secondary flow fraction 410;
determining with the automatic controller 300 the arm primary flow request command 438 to the arm primary valve 210 based at least in part on the target hydraulic flow 426 to the hydraulic arm actuator 122 and the arm primary flow fraction 412; and
determining with the automatic controller 300 the arm secondary flow request command 442 to the arm secondary valve 212 based at least in part on the target hydraulic flow 426 to the hydraulic arm actuator 122 and the arm secondary flow fraction 414.

Thus, it is seen that the apparatus and methods of the embodiments disclosed herein readily achieve the ends and advantages mentioned as well as those inherent therein. While certain preferred embodiments have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. A work machine, comprising:
a machine frame;
a boom pivotally connected to the machine frame;
an arm pivotally connected to the boom;
a work implement connected to the arm;
a hydraulic boom actuator arranged to pivot the boom relative to the machine frame;
a hydraulic arm actuator arranged to pivot the arm relative to the boom;
a hydraulic boom supply pump configured to primarily provide hydraulic fluid to the hydraulic boom actuator;
a hydraulic arm supply pump configured to primarily provide hydraulic fluid to the hydraulic arm actuator;
a boom primary valve configured to control flow of hydraulic fluid from the hydraulic boom supply pump to the hydraulic boom actuator;
a boom secondary valve configured to control flow of hydraulic fluid from the hydraulic arm supply pump to the hydraulic boom actuator;
an arm primary valve configured to control flow of hydraulic fluid from the hydraulic arm supply pump to the hydraulic arm actuator;
an arm secondary valve configured to control flow of hydraulic fluid from the hydraulic boom supply pump to the hydraulic arm actuator;
an operator input configured to allow a human operator of the work machine to select a selected operating mode from a group of selectable operating modes, the selected operating mode corresponding to a degree of precision selected for accomplishing a work task;
at least one parameter sensor configured to detect a machine parameter corresponding to an operating condition of the work machine; and
a controller configured to:
receive a signal indicating the selected operating mode;
receive an operating command for operation of the work implement;
determine a target hydraulic flow to the hydraulic boom actuator and a target hydraulic flow to the hydraulic arm actuator to perform the operating command;
determine a flow split of the hydraulic flow to be provided to the hydraulic boom actuator between a boom primary flow fraction from the hydraulic boom supply pump and a boom secondary flow fraction from the hydraulic arm supply pump, based at least in part on at least one of the selected operating mode or the operating condition;
determine a flow split of the hydraulic flow to be provided to the hydraulic arm actuator between an arm primary flow fraction from the hydraulic arm supply pump and an arm secondary flow fraction from the hydraulic boom supply pump, based at least in part on at least one of the selected operating mode or the operating condition;
determine a boom primary flow request command to the boom primary valve based at least in part on the target hydraulic flow to the hydraulic boom actuator and the boom primary flow fraction;
determine a boom secondary flow request command to the boom secondary valve based at least in part on the target hydraulic flow to the hydraulic boom actuator and the boom secondary flow fraction;
determine an arm primary flow request command to the arm primary valve based at least in part on the target hydraulic flow to the hydraulic arm actuator and the arm primary flow fraction; and
determine an arm secondary flow request command to the arm secondary valve based at least in part on the target hydraulic flow to the hydraulic arm actuator and the arm secondary flow fraction.

2. The work machine of claim 1, wherein:
for each of the operating modes the arm secondary flow fraction is greater than zero.

3. The work machine of claim 2, wherein:
for each of the operating modes the boom secondary flow fraction is greater than zero.

4. The work machine of claim 1, wherein:
for each of the operating modes the boom secondary flow fraction is greater than zero.

5. The work machine of claim 1, wherein:
the selected operating mode is a selectable grade control performance setting.

6. The work machine of claim 5, wherein:
the group of selectable operating modes includes a higher speed-lower precision mode and a lower speed-higher precision mode.

7. The work machine of claim 6, wherein:
the controller is configured to provide a higher boom primary flow fraction in the lower speed-higher precision mode than in the higher speed-lower precision mode; and
the controller is configured to provide a higher arm primary flow fraction in the lower speed-higher precision mode than in the higher speed-lower precision mode.

8. The work machine of claim 1, wherein:
the operator input is configured to allow the human operator of the work machine to select between a manual control mode and a grade control mode; and
the controller is configured to adjust the flow split of the hydraulic flow to be provided to the hydraulic boom actuator and/or the flow split of the hydraulic flow to be provided to the hydraulic arm actuator, in response to a change between the manual control mode and the grade control mode.

9. The work machine of claim 8, wherein:
the controller is configured such that when the operator is manually controlling movement of the work implement toward grade the boom primary flow request and the boom secondary flow request are each greater than each of the arm primary flow request and the arm secondary flow request.

10. The work machine of claim 8, wherein:
the controller is configured such that when the operator is controlling movement of the work implement within a grade control window the boom primary flow request and the arm primary flow request are each greater than each of the boom secondary flow request and the arm secondary flow request.

11. The work machine of claim 8, wherein:
the controller is configured such that when the operator is controlling movement of the work implement on grade, the boom primary flow request is equal to the boom secondary flow request plus or minus 10%, and the arm primary flow request is equal to the arm secondary flow request plus or minus 10%.

12. The work machine of claim 8, further comprising:
an auxiliary hydraulically powered component;
wherein the controller is configured such that when the operator is controlling movement of the work implement within a grade control window or on grade, and the auxiliary powered hydraulic component is being simultaneously operated, hydraulic flow is distributed from one or both of the hydraulic boom supply pump and the hydraulic arm supply pump to the auxiliary hydraulically powered component.

13. The work machine of claim 12, wherein:
the at least one parameter sensor is configured to detect operation of the auxiliary powered hydraulic component.

14. The work machine of claim 1, wherein:
the at least one parameter sensor includes a machine orientation sensor configured to detect an orientation of the boom, the arm or the work implement.

15. A work machine, comprising:
a plurality of hydraulic actuators;
a plurality of hydraulic pumps, each of the hydraulic pumps being primarily associated with a different one of the hydraulic actuators;
a plurality of primary control valves, each of the primary control valves being associated with a different one of the hydraulic actuators;
a plurality of secondary control valves, each of the secondary control valves being associated with a different one of the hydraulic actuators;
an operator input configured to allow a human operator of the work machine to select a selected operating mode from a group of operating modes, the selected operating mode corresponding to a degree of precision selected for accomplishing a work task; and
a controller configured to:
receive a signal indicating the selected operating mode;
receive an operating command for performance of the work task;
determine a needed flow rate of hydraulic fluid needed by each of the hydraulic actuators to perform the work task;
determine a flow split for each hydraulic actuator, the flow split defining a percentage of the needed flow rate to be provided from each of the primary control valve and the secondary control valve associated with the hydraulic actuator, the flow split being based at least in part on the selected operating mode, wherein for each of the operating modes the percentage of the needed flow rate to be provided from the secondary control valve associated with the hydraulic actuator is greater than zero; and
provide command signals to each of the primary control valves and secondary control valves to accomplish the determined flow split for each of the hydraulic actuators.

16. The work machine of claim 15, further comprising:
at least one parameter sensor configured to detect a machine parameter corresponding to an operating condition of the work machine;
wherein the flow split is also based at least in part on the operating condition of the work machine.

17. The work machine of claim 15, wherein:
the selected operating mode is a selectable grade control performance setting;
the group of selectable operating modes includes a higher speed-lower precision grade control mode and a lower speed-higher precision grade control mode; and
the controller is configured to provide a higher percentage of the needed flow rate to be provided from the primary control valve associated with each hydraulic actuator in the lower speed-higher precision grade control mode than in the higher speed-lower precision grade control mode.

18. The work machine of claim 15, wherein:
the operator input is configured to allow the human operator of the work machine to select between a manual control mode and a grade control mode; and
the controller is configured to adjust the flow split of the hydraulic flow to be provided to each of the hydraulic actuators, in response to a change between the manual control mode and the grade control mode.

19. The work machine of claim 18, wherein:
the work machine is an excavator including a work implement; and
controller is configured such that when the operator is manually controlling movement of the work implement toward a grade a lower flow split is provided to the respective primary control valve associated with each hydraulic actuator than when the operator is controlling movement of the work implement within a grade control window or on grade.

20. A method of operating a work machine, the work machine including a machine frame, a boom pivotally connected to the machine frame, an arm pivotally connected to the boom, a work implement connected to the arm, a hydraulic boom actuator arranged to pivot the boom relative to the machine frame, and a hydraulic arm actuator arranged to pivot the arm relative to boom, the method comprising:
receiving in an automatic controller a signal indicating a selected operating mode from a group of selectable operating modes, the selected operating mode corresponding to a degree of precision selected for accomplishing a work task with the work implement;
receiving in the automatic controller an operating command for operation of the work implement;
determining with the automatic controller a target hydraulic flow to the hydraulic boom actuator and a target hydraulic flow to the hydraulic arm actuator to perform the operating command;
determining with the automatic controller a flow split of the hydraulic flow to be provided to the hydraulic boom actuator between a boom primary flow fraction from a hydraulic boom supply pump and a boom secondary flow fraction from a hydraulic arm supply pump, based at least in part on the selected operating mode or based at least in part on an operating condition of the work machine;
determining with the automatic controller a flow split of the hydraulic flow to be provided to the hydraulic arm actuator between an arm primary flow fraction from the hydraulic arm supply pump and an arm secondary flow fraction from the hydraulic boom supply pump, based at least in part on the selected operating mode or based at least in part on the operating condition of the work machine;
determining with the automatic controller a boom primary flow request command to a boom primary valve based at least in part on the target hydraulic flow to the hydraulic boom actuator and the boom primary flow fraction;
determining with the automatic controller a boom secondary flow request command to a boom secondary valve based at least in part on the target hydraulic flow to the hydraulic boom actuator and the boom secondary flow fraction;
determining with the automatic controller an arm primary flow request command to an arm primary valve based at least in part on the target hydraulic flow to the hydraulic arm actuator and the arm primary flow fraction; and
determining with the automatic controller an arm secondary flow request command to an arm secondary valve based at least in part on the target hydraulic flow to the hydraulic arm actuator and the arm secondary flow fraction;
wherein for each of the operating modes the arm secondary flow fraction and the boom secondary flow fraction are greater than zero.
